(19) United States
(12) Patent Application Publication
(10) Pub. No.: US 2026/0193492 A1
(43) Pub. Date: Jul. 9, 2026

(54) MULTI-LAYER ADHESIVE FILM, PREPARATION METHOD AND USE THEREOF

(71) Applicant: Henkel AG & Co. KGaA, Duesseldorf (DE)

(72) Inventors: Dongmei Shen, Shanghai (CN); Yizhong Luo, Shanghai (CN); Bingbing Guo, Shanghai (CN)

(21) Appl. No.: 19/553,980

(22) Filed: Mar. 2, 2026

Related U.S. Application Data
(63) Continuation of application No. PCT/CN2023/116144, filed on Aug. 31, 2023.

(51) Int. Cl. C09J 7/35; C09J 175/04

(52) U.S. Cl. CPC C09J 7/35; C09J 175/04; C09J 2301/122; C09J 2301/208; C09J 2301/304; C09J 2301/408; C09J 2475/00

(57) ABSTRACT

The present invention provides a multi-layer adhesive film, preparation method, and use thereof. In particular, disclosed herein is a multi-layer adhesive film that exhibits excellent impact resistance, good bonding strength and outstanding rework ability when cured at a low temperature, such as no more than 90° C.

### TECHNICAL FIELD

The present invention relates to a multi-layer adhesive film, preparation method, and use thereof. In particular, disclosed herein is a multi-layer adhesive film that exhibits excellent impact resistance, good bonding strength and outstanding rework ability when cured at a low temperature, such as no more than 90° C.

### BACKGROUND OF THE INVENTION

Heat-activated adhesive films have been widely used in manufacturing electronics to assemble substrates. The term “heat-activated” (or “thermally activatable) refers to a composition that has latent adhesive properties that are only activated after being heated above a given temperature. Such compositions have other advantages, such as being simple and rapid to employ, self-supported, etc. During the manufacturing process, a heat-activated adhesive film is placed between the surfaces of the substrates to be assembled and held in contact with them. At the same time, the assembly is heated to activate the adhesive composition. The heating time can vary with the thickness of the substrates but would not be too long to avoid the thermal deformation of the substrates. Sometimes, a pre-lamination can partially cure the adhesive film at a lower temperature partially, and a final lamination can cure the adhesive film and fully bond the substrates. After cooling, an adhesive film with specific bonding strength is obtained to assemble the substrates.

Current heat-activated adhesive films disclosed in the prior art or existing on the market are based on thermoplastic polymers, polyols, and NCO-terminated isocyanates. It has been observed that such adhesive films exhibit either insufficient impact resistance and bonding strength when cured at a low temperature (no more than 90° C.) or unsatisfactory rework ability, causing damage or leaving residue on the substrates, which cannot meet the electronics manufacturing requirement.

Given the above, there is a need for a multi-layer adhesive film that exhibits excellent impact resistance, bonding strength and outstanding rework ability when cured at a low temperature, such as no more than 90° C.

### SUMMARY OF THE INVENTION

According to a first aspect of the invention, disclosed herein is a multi-layer adhesive film comprising:
a first layer having a first major surface and a second major surface opposite the first major surface, and
a second layer disposed on the first major surface of the heat-activated adhesive film;
   wherein the first layer is a heat-activated adhesive film prepared by drying a solvent-based heat-activated adhesive composition (A) until the solvent content is no more than 5% by weight of the total solvent-based heat-activated adhesive composition, and the solvent-based heat-activated adhesive composition (A) comprises at least one thermoplastic polymer (A1), at least one polyol (A2), at least one polyisocyanate having at least two isocyanate groups and at least one uretdione group in one molecule (A3) and an organic solvent (A4);
   wherein the second layer is derived from a dispersion composition (B) comprising at least one water-based polyurethane dispersion (B1) and optionally a latent curing agent (B2).

A second aspect of the invention is a method for preparing a multi-layer adhesive film according to the present invention.

A third aspect of the invention is an article comprising a first substrate, a second substrate, and the multi-layer adhesive film according to the present invention disposed between the first substrate and the second substrate.

A fourth aspect of the invention is the use of the multi-layer adhesive film according to the present invention or the article comprising the multi-layer adhesive film in manufacturing automobile parts, truck bed covers, textile laminations, assembled goods, and electronic devices.

Other features and aspects of the subject matter are outlined in greater detail below.

### DETAILED DESCRIPTION OF THE INVENTION

It is to be understood by one of ordinary skill in the art that the present invention is a description of exemplary embodiments only and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, in the context of the present invention, the terms used are to be construed in accordance with the following definitions.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

The term “at least one” or “one or more” used herein to define a component refers to the type of the component, and not to the absolute number of molecules. For example, “one or more polyols” means one type of polyol or a mixture of a plurality of different polyols.

The term “heat-activated” is understood to mean that the adhesive film has latent adhesive properties which are only activated after having heated said film above a given temperature (“activation temperature”). It is during this thermal activation stage that the film will develop its adhesive properties.

The term “adhesive film” means an adhesive in a form of a film.

The term “self-supporting adhesive film” means an adhesive film that maintains its integrity in the absence of any substrate.

In the content of the present invention, a “liner” or “detachable liner” is not considered a substrate.

The term “polyurethane” means polyurethane as well as polyurethane that contains urea groups in the backbone of the polyurethane.

The term “room temperature” as used herein refers to a temperature of about 20° C. to about 25° C., preferably about 25° C.

Unless specified otherwise, the recitation of numerical end points includes all numbers and fractions subsumed within the respective ranges, as well as the recited end points.

All references cited in the present specification are hereby incorporated by reference in their entirety.

The molecular weights refer to number average molecular weights (Mn), unless otherwise stipulated. All molecular weight data refer to values obtained by gel permeation chromatography (GPC), unless otherwise stipulated, e.g., according to DIN 55672.

The softening point mentioned herein is determined by using Ring and Ball method according to DIN ISO 4625.

Unless otherwise defined, all terms used in the present invention, including technical and scientific terms, have the meaning as commonly understood by one of the ordinary skilled in the art to which this invention belongs.

In one aspect, the present disclosure is a multi-layer adhesive film comprising:
a first layer having a first major surface and a second major surface opposite the first major surface, and
a second layer disposed on the first major surface of the heat-activated adhesive film;
   wherein the first layer is a heat-activated adhesive film prepared by drying a solvent-based heat-activated adhesive composition (A) until the solvent content is no more than 5% by weight of the total solvent-based heat-activated adhesive composition, and the solvent-based heat-activated adhesive composition (A) comprises at least one thermoplastic polymer (A1), at least one polyol (A2), at least one polyisocyanate having at least two isocyanate groups and at least one uretdione group in one molecule (A3) and an organic solvent (A4);
   wherein the second layer is derived from a dispersion composition (B) comprising at least one water-based polyurethane dispersion (B1) and optionally a latent curing agent (B2).

### (A) Solvent-Based Heat-Activated Adhesive Composition

According to the present invention, the solvent-based heat-activated adhesive composition (A) comprises at least one thermoplastic polymer (A1), at least one polyol (A2), at least one polyisocyanate having at least two isocyanate groups and at least one uretdione group in one molecule (A3) and an organic solvent (A4).

### (A1) Thermoplastic Polymer

The thermoplastic polymer (A1) provides the backbones to the heat-activated adhesive film. Without a thermoplastic polymer, the multi-layer adhesive film cannot realize a self-supporting adhesive film.

A thermoplastic polymer is distinct from a thermosetting polymer, which solidifies via crosslinking or curing when subjected to heat, while a thermoplastic polymer is pliable at elevated temperatures and solidifies when cooled.

In some embodiments, the thermoplastic polyurethane polymer (A1) can have a weight-molecular weight (Mw) no less than 10,000 g/mol, preferably from 10,000 to 200,000 g/mol, preferably from 10,000 to 150,000 g/mol, and more preferably from 20,000 to 100,000 g/mol.

In some embodiments, the thermoplastic polymer (A1) exhibits an optimum activation temperature of no greater than 100° C., preferably less than 85° C., preferably from 30° C. to less than 80° C., much preferably from 30° C. to less than 70° C., even much preferably from 30° C. to less than 60° C. Within the preferred range, the heat-activated adhesive film derived from the solvent-based heat-activated adhesive composition (A) can self-supporting and exhibiting certain bonding strength when cured at a low temperature, such as no more than 90° C.

The term “optimum activation temperature” described herein means a temperature range (or point) of a thermoplastic polymer at which coalescence occurs within the thermoplastic polymer (physically), which has satisfactory strength with a proportion of non-coalescence of less than 10%. The optimum activation temperature of a thermoplastic polymer described herein can be determined according to EN 12961:2001.

Generally, the thermoplastic polymer (A1) described herein is non-reactive chemically; when subject to heat, coalescence occurs and results in a pliable status with certain adhesive properties. In some embodiments, the thermoplastic polymer (A1) may comprise hydroxyl groups that can react with component (A3).

A wide variety of known thermoplastic polymers can be used in the present invention. The suitable thermoplastic polymer used in the present invention can be selected from groups consisting of thermoplastic polyurethane polymers, polyester polymers, acrylic polymers, ethylene-vinyl acetate copolymers, styrene block copolymers, polyvinyl acetols, styrene acrylonitriles, polyolefins, polyacrylonitriles, ethylene vinyl acetate terpolymers, functional ethylene vinyl acetates, ethylene acrylate copolymers, ethylene acrylate terpolymers, ethylene butadiene copolymers, and block copolymers, preferably selected from thermoplastic polyurethane polymers, polyester polymers, acrylic polymers, styrene block copolymers, and a combination thereof.

In some embodiments, thermoplastic polyurethane polymers can be used as component (A1) in the present invention. Suitable thermoplastic polyurethane polymers can be obtained from the reaction of ring opening polymerization of a lactone such as &-caprolactone or polyester polyols and polyether polyols with diisocyanates and optionally also from the further reaction of such components with chain-extending agents such as low molecular weight polyols, preferably diols, or with diamines to form urea linkages.

Examples of useful polyester polyols used to prepare the thermoplastic polyurethane polymers used as component (A1) include, e.g., polyester polyols derived from linear dicarboxylic acids, derivatives of dicarboxylic acids (e.g., anhydrides, esters and acid chlorides), aliphatic polyols, cycloaliphatic polyols, linear polyols, branched polyols, and combinations thereof. Examples of useful dicarboxylic acids from which the polyester polyol can be derived include adipic acid, succinic acid, sebacic acid, dodecanedioic acid, phthalic acid, isophthalic acid, terephthalic acid, phthalic anhydride, dimer acid, and combinations thereof. Examples of useful aliphatic diols from which the polyester polyol can be derived include ethylene glycol, 1,3-propanediol, 1,4-butanediol, 1,5-pentanediol, 1,6-hexanediol, neopentyl glycol, diethylene glycol, methyl propanediol, 3-methyl-1,5-propanediol and combinations thereof.

Examples of useful polyether polyols used to prepare the thermoplastic polyurethane polymers used as component (A1) can be obtained from the polymerization of a cyclic oxide, e.g., ethylene oxide, propylene oxide, butylene oxide, and tetrahydrofuran, or by the addition of one or more such oxides to polyfunctional initiators having at least two active hydrogens, e.g., water, polyhydric alcohols (e.g., ethylene glycol, propylene glycol, diethylene glycol, cyclohexane dimethanol, glycerol, trimethylol-propane, pentaerythritol, and bisphenol A), ethylenediamine, propylene diamine, triethanolamine, and 1,2-propanedithiol.

Useful thermoplastic polyurethane polymers used as thermoplastic polymers (A1) are generally composed of soft segments, for example, polyether or polyester polyols, and hard segments, usually derived from the reaction of the low molecular weight diols and diisocyanates. Commercially available thermoplastic polyurethane polymers used as component (A1) include but not limited to Pearlstick series such as 5707, 5703, 5701, 5714, 5713, 5715, 45-40, 45-50, 45-60, 45-80, 45-90, 48-60, 40-70, 46-10 from Lubrizol, HF-4003LH, 3003EH series, HF-3H, 6H series from Huafeng Chemicals, and WHT-61, 63, 64, 65, 67 series from Wanhua Chemicals.

Suitable polyester polymers used as component (A1) can be obtained by polycondensation of at least one polyester diol, such as ethylene glycol, diethylene glycol, trimethylene glycol, butanediol (1,4-butanediol; 1,2-butanediol; 1,3-butanediol), neopentyl glycol, 2-methyl-1,3-propanediol, hexanediol (hexamethylene glycol), propanediol (propane-1,2-diol, propane-1,3-diol or propylene glycol), trimethylolpropane, cyclohexanedimethanol, or combination and of at least one dicarboxylic acid or one of its ester or anhydride derivatives, such as terephthalic acid, dimethyl terephthalate, isophthalic acid, adipic acid, azelaic acid, sebacic acid, cyclohexanedicarboxylic acid, dodecanoic acid (1,10-decanedicarboxylic acid), succinic acid, dimer acid, phthalic anhydride, maleic anhydride, and hydroxycarboxylic acids, such as the diesters obtained from polycaprolactone or ε-caprolactone and diethylene glycol, or combination. Commercially available polyester polymers used as component (A1) include but are not limited to BX1001 manufactured by TOYOBO, CAPA™ 6800, 6500, 6400 under Perstorp, PLACCEL H series manufactured by Daicel, and PCL65000, PCL68000 from Hunan Juren Chemical.

Polymerizing esters of acrylic and methacrylic acid monomers can obtain suitable acrylic polymers used as component (A1). Exemplary useful monomers used to synthesize component (A) include soft monomers such as ethyl acrylate, 2-ethylhexyl acrylate, n-butyl acrylate, and hard monomers such as methyl methacrylate, isobutyl acrylate. Exemplary acrylic polymers used as component (A1) include polymethyl methacrylate, n-butyl acrylate-based block copolymers, n-butyl acrylate/2-ethylhexyl acrylate-based block copolymers, and a combination thereof. It is preferable to use acrylic block polymers derived from soft and hard monomers. Commercially available acrylic polymers used as component (A1) include but are not limited to n-butyl acrylate-methyl methacrylate copolymer under Kuraray™ LA2140 manufactured by SANYO and the like.

Suitable styrene block copolymers used as component (A1) include an aromatic vinyl polymer block and a saturated midblock, preferably a hydrogenated conjugated diene polymer block or an unsaturated midblock. The blocks can be arranged in various configurations, e.g., linear, branched, radial, star, and combinations. The aromatic vinyl polymer block can be derived from various aromatic vinyl compounds including, e.g., styrene, alpha-methylstyrene, beta-methylstyrene, o-, m-, p-methylstyrene, t-butylstyrene-2,4,6-trimethylstyrene, monofluorostyrene, difluorostyrene, monochlorostyrene, dichlorostyrene, methoxystyrene, 1,3-vinylnaphthalene, vinylanthracene, indene, acenaphthylene, and combinations thereof. The hydrogenated diene polymer block can be derived from a variety of diene-containing compounds including, e.g., isoprene, butadiene, hexadiene, 2,3-dimethyl-1,3-butadiene, 1,3-pentadiene, and combinations thereof. Useful styrene block copolymers having saturated midblock used as component (A1) include, e.g., triblock, multi-arm, and radial copolymers including, e.g., styrene-ethylene/butene-styrene (SEBS), styrene-ethylene/propylene-styrene (SEPS), styrene-ethylene-ethylene/propylene-styrene (SEEPS), styrene/isobutylene/styrene (SIBS), and combinations thereof. Useful styrene block copolymers having unsaturated midblock used as component (A1) include styrene-butadiene-styrene (SBS), styrene-isoprene-styrene (SIS), styrene-butadiene-isobutylene-styrene (SBBS), styrene-isoprene-butadiene-styrene (SIBS), and combination thereof. Commercially available styrene block copolymers used as component (A1) include but are not limited to HYBRAR™ 5125 and 7311 from Kuraray.

Suitable ethylene-vinyl acetate copolymers used as component (A1) are derived from at least one ethylene monomer and at least one vinyl acetate monomer. From the perspective of strength and flexibility of the heat-activated adhesive film, preferably the ethylene-vinyl acetate copolymers used as component (A1) have a vinyl acetate content of 18 mass % or greater. Commercially available ethylene-vinyl acetate copolymers used as component (A1) include but are not limited to Levamelt™ 686 from ARLANXEO (68 wt % vinyl acetate), KBE-68 A and KBE-68 B manufactured by Kuraray Co., Ltd., and the like.

Other useful thermoplastic polymers used as component (A1) include but are not limited to polyvinyl acetols, styrene acrylonitriles, polyolefins, polyacrylonitriles, ethylene vinyl acetate terpolymers, functional ethylene vinyl acetates, ethylene acrylate copolymers, ethylene acrylate terpolymers, ethylene butadiene copolymers and block copolymers, and a combination thereof.

The thermoplastic polymers mentioned above can be used singly or in combination with two or more.

With particular preference, the component (A1) may be present from 1% to 95%, preferably from 10% to 40% by weight, based on the total weight of the solvent-based heat-activated adhesive composition (A).

### (A2) Polyol

According to the present invention, the solvent-based heat-activated adhesive composition (A) comprises at least one polyol (A2), which can react with component (A3) described below to form an effective bonding subject to heat.

Useful polyol (A2) in the present invention include those carrying at least two hydroxyl groups in one molecule, for example three hydroxyl groups or four hydroxyl groups and having aromatic group(s) in the molecule, preferably has a hydroxyl number of no less than 10 mg KOH/g, preferably greater than or equal to 15 mg KOH/g, much preferably ranging from 20 to 90 mg KOH/g, even much more preferably from 30 to 60 mg KOH/g.

Preferably, the component (A2) is a polyester polyol having a weight-molecular weight (Mw) of less than 10,000 g/mol.

The component (A2) used in the present invention is preferably solid at ambient temperature (20° C.). In some embodiments, the component (A2) can be selected from an amorphous polyester polyol, semi-crystalline polyester polyol, crystalline polyester polyol, and a combination thereof, from the perspective of dissolving in the organic solvent, preferably amorphous polyester polyol, semi-crystalline polyester polyol and a combination thereof.

The term “amorphous polyester polyol” used herein means a polyester polyol having no melt transition when measured using Differential Scanning calorimetry (DSC), which does not have a crystalline form. It preferably has a degree of crystallinity by weight of less than 10%, preferably of less than 5%, advantageously of less than 2%, and more advantageously still of less than 1%.

The term “semicrystalline polyester polyol” means a polyester polyol comprising crystalline and amorphous regions in its structure. It preferably has a degree of crystallinity by weight of at least 20% to less than 80%, more preferably at least 30% to less than 80%, and even more preferably at least 40% and less than 80%.

The term “crystalline polyester polyol” used herein means a polyester polyol having a melt transition when measured using Differential Scanning calorimetry (DSC), which has a crystalline form. It preferably has a degree of crystallinity by weight of at least 80%, preferably at least 90%.

The degree of crystallinity, denoting the proportion of substance in the crystalline state, can be determined by X-ray diffraction analysis at different angles of incidence, by calorimetric measurements, such as DSC (Differential Scanning calorimetry), or by any other technique that makes it possible to estimate the proportion of crystalline phase of the semicrystalline polyester polyol.

Useful amorphous polyester polyols used as component (A2) in the present invention include a reaction product of a polyacid component (e.g., polyacid, polyacid anhydride, polyacid ester, and polyacid halide) and a stoichiometric excess of polyol. At least one polyacid component and the polyol include an aromatic group. Suitable polyacids include, e.g., diacids (e.g., dicarboxylic acids), triacids (e.g., tricarboxylic acids), and higher order acids, examples of which include aromatic dicarboxylic acids, anhydrides and esters thereof (e.g. terephthalic acid, isophthalic acid, dimethyl terephthalate, diethyl terephthalate, phthalic acid, phthalic anhydride, methyl-hexahydrophthalic acid, methyl-hexahydrophthalic anhydride, methyl-tetrahydrophthalic acid, methyl-tetrahydrophthalic anhydride, hexahydrophthalic acid, hexahydrophthalic anhydride, and tetrahydrophthalic acid), aliphatic dicarboxylic acids and anhydrides thereof (e.g. maleic acid, maleic anhydride, succinic acid, succinic anhydride, glutaric acid, glutaric anhydride, adipic acid, pimelic acid, suberic acid, azelaic acid, sebacic acid, chlorendic acid, 1,2,4-butane-tricarboxylic acid, decanedicarboxylic acid, octadecanedicarboxylic acid, dimeric acid, dimerized fatty acids, trimeric fatty acids, and fumaric acid), and alicyclic dicarboxylic acids (e.g. 1,3-cyclohexanedicarboxylic acid, and 1,4-cyclohexanedicarboxylic acid), and mixture thereof. Examples of suitable polyols include aliphatic polyols, e.g., ethylene glycols, propane diols (e.g., 1,2-propanediol and 1,3-propanediol), butanediols (e.g., 1,3-butanediol, 1,4-butanediol, and 1,2-butanediol), 1,3-butenediol, 1,4-butenediol, 1,4-butynediol, pentane diols (e.g., 1,5-pentanediol), pentenediols, pentynediols, 1,6-hexanediol, 1,8-octanediol, 1,10-decanediol, neopentyl glycol, diethylene glycol, triethylene glycol, tetraethylene glycol, polyethylene glycols, propylene glycol, polypropylene glycols (e.g., dipropylene glycol and tripropylene glycol), 1,4-cyclohexanedimethanol, 1,4-cyclohexanediol, dimer diols, bisphenol A, bisphenol F, hydrogenated bisphenol A, hydrogenated bisphenol F, glycerol, tetramethylene glycol, polytetramethylene glycol, 3-methyl-1,5-pentanediol, 1,9-nonanediol, 2-methyl-1,8-octanediol, trimethylolpropane, pentaerythritol, sorbitol, glucose, and a combination thereof.

Specific examples of useful amorphous polyester polyols include poly(hexanediol phthalate) polyol, poly(neopentyl glycol adipate) polyol, poly(neopentyl glycol phthalate) polyol, poly(neopentyl glycol hexanediol phthalate) polyol, poly(diethylene glycol phthalate) polyol, poly(ethylene glycol adipic acid terephthalate) polyol, polyethylene terephthalate polyols, random copolymer diols of ethylene glycol, hexane diol, neopentyl glycol, adipic acid and terephthalic acid, and combinations thereof.

When solid amorphous polyester polyol is used, it is preferable for it to have a softening point of no greater than 130° C., preferably no greater than 120° C., preferably no greater than 105° C., for example, 60° C., 80° C., 100° C., from the viewpoints of achieving good bonding strength when fully cured, and easy to dissolve in the solvent-based heat-activated adhesive composition (A).

Suitable crystalline polyester polyols as component (A2) in the present invention can be obtained by ring-opening polymerizing a lactone, such as ε-caprolactone, or be derived from diols and diacids. Exemplary diols in preparing preferred polyester polyols include ethylene glycol, diethylene glycol, 1,3-propylene glycol, 1,4-butanediol, 1,5-pentanediol, 1,6-hexanediol, 1,8-octanediol, 1,10-decanediol, and combinations thereof. Examples of diacids in preparing preferred polyester polyols include succinic acid, glutaric acid, adipic acid, suberic acid, azelaic acid, sebacic acid, and 1,12-dodecanedioic acid, dimer acid, and combinations thereof. Included within the scope of diacids are various diacid derivatives such as carboxylate esters (especially the methyl and ethyl esters), acid halides (such as acid chlorides), acid anhydrides, and a combination thereof.

Specific examples of suitable crystalline polyester polyols include poly(hexanediol adipate) polyol, poly(butanediol adipate) polyol, poly-epsilon-caprolactone polyol, poly(hexanediol dodecanedioate) polyol, poly(hexanediol adipic acid terephthalate) polyol, and a combination thereof.

The polyol mentioned above can be used singly or in combination with two or more thereof.

Suitable commercially available polyols (A2) are sold under FZPE-A03130 from GUANGZHOU FTRT CHEMICAL CO., LTD, DYNACOLL 7110, 7130, 7140, and 7150 from Evonik Industries AG, and FLP PA-1000N from Xuchuan Chemical (Suzhou) Co., Ltd. and the like.

With particular preference, the component (A2) may be present from 0.01% to 80%, preferably from 5% to 40%, based on the total weight of the solvent-based heat-activated adhesive composition (A).

### (A3) Polyisocyanate

According to the present invention, the solvent-based heat-activated adhesive composition (A) comprises at least one polyisocyanate having at least two isocyanate groups and at least one uretdione group in one molecule (A3).

Useful polyisocyanate(s) (A3) which can be used according to the invention correspond(s) to the following formula (I):

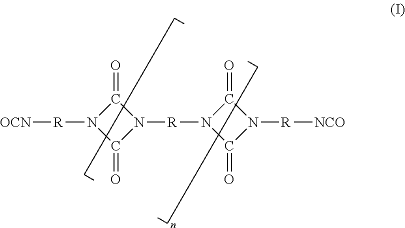

in which:
R is a divalent group comprising from 6 to 13 carbons and
n is an integer ranging from 0 to 10.

Preferably, R is a divalent aromatic or polyaromatic group, more preferably resulting from an aromatic diisocyanate, such as toluene diisocyanate (TDI) or diphenylmethane diisocyanate (MDI).

Examples of the polyisocyanate(s) (A3) which can be used according to the invention correspond(s) to one of the following formulae (1-1) or (1-2):

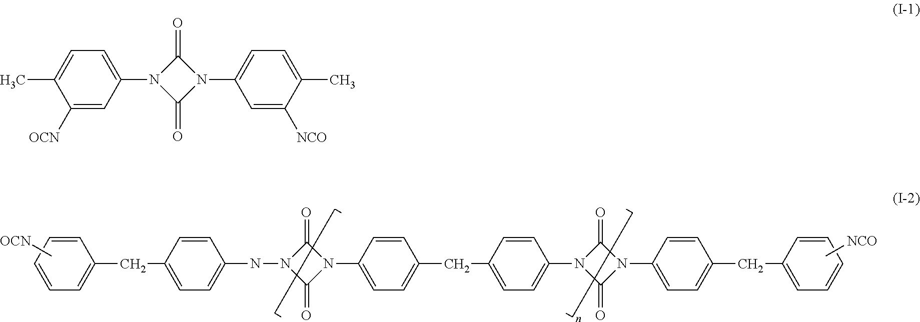

Preferably, the polyisocyanate(s) (A3) which can be used according to the invention, exhibit(s) a content of NCO ranging from 15% to 40% by weight, more preferably from 20% to 35% by weight, with respect to the weight of said polyisocyanate.

Preferably, the solvent-based heat-activated adhesive composition (A) has an NCO/OH molar ratio ranges from 0.1 to 8:1. The isocyanate groups are contributed by component (A3) present in the solvent-based heat-activated adhesive composition (A) according to the invention and the hydroxyl groups are contributed by the component (A2) and minor hydroxy groups in component (A1), if any, according to the invention. Under the condition that the above molar ratio is satisfied, the weight percentages of the polyol (A2) and the polyisocyanate (A3) are not particularly limited.

Suitable commercially available polyisocyanates (A3) are sold under the Grilbond™ A2bond (MDI uretdione), sold by EMS-Griltech, Addolink™ TT (TDI uretdione), sold by Rhein Chemie.

With particular preference, the component (A3) may be present from 0.05% to 20%, preferably from 0.5% to 5% by weight, based on the total weight of the solvent-based heat-activated adhesive composition (A).

### (A4) Organic Solvent

According to the present invention, the solvent-based heat-activated adhesive composition (A) comprises at least one organic solvent (A4).

The organic solvent (A4) that can be used according to the invention is (are) preferably such that the components (A1) and (A2), as well as other optional components or additives, are soluble in the organic solvent (A4), forming a mixture, and the component (A3) can disperse homogeneously in the said mixture, rendering the solvent-based heat-activated adhesive composition (A) easy to employ on a substrate.

Preferably, the organic solvent (A4) has a solubility parameter, delta (δ) (also known as Hildebrand solubility parameter, HSP), ranging from 6.9 to 10.0 (cal/cm3)1/2 and a hydrogen bonding index (HBI), gamma (γ), ranging from 5.0 to 7.7. These parameters are defined in a well-known way in the literature, such as, for example, in sections 38 and 39 of the patent application US 2004/0204524:
the solubility parameter delta is defined in Römpp Lexikon Lacke and Druckfarben, Georg Thieme Verlag, Stuttgart, New York, 1998, “Solubility parameters,” pp 361 to 365;
the hydrogen bonding index describes the ability of a solvent molecule to form hydrogen bonds. The donor solvents have a negative hydrogen bonding index, and the acceptor solvents have a positive one. The hydrogen bonding index is determined according to the deviation of the infrared band for the RO-H stretching band (R. C. Nelson, R. W. Hemwall and G. D. Edwards, Journal of Paint Technology, “Treatment of hydrogen bonding in predicting miscibility,” Vol. 42, No. 550, 1970, pp 636 to 643). Preferably, the organic solvent (A4) is selected from groups consisting of ketones, preferably aliphatic ketones, more preferably the groups consisting of acetone, methyl ethyl ketone (MEK), 2-pentanone, 3-pentane, methyl isobutyl ketone, ethyl acetate and combination thereof.

Preferably, the organic solvent (A4) has a boiling point of less than the optimum activation temperature of the thermoplastic polymer (A1) to ensure the organic solvent can be evaporated to form the thermal curable adhesive film without activating the thermoplastic polymer (A1), for example, less than 100° C., more preferably less than 80° C.

The component mentioned above (A4) can be used singly or in combination with two or more.

In a particular embodiment, the organic solvent (A4) is present from greater than 36% to 95%, preferably from 50% to 85% by weight based on the total weight of the solvent-based heat-activated adhesive composition (A). After drying, the heat-activated adhesive film has less than 2.0% by weight, preferably less than 0.5% by weight, and preferentially less than 0.1% by weight of at least one organic solvent, based on the total weight of the heat-activated adhesive film.

The solvent-based heat-activated adhesive composition (A), according to the invention, may or may not comprise at least one optional component selected from silanes, pigments e.g., carbon black, defoamer agents, leveling agents, stabilizers (antioxidant, UV stabilizer, heat stabilizer), catalysts, dyes and their mixtures, subject to not modifying the advantageous properties of solvent-based heat-activated adhesive composition (A) according to the invention.

According to the invention, the solvent-based heat-activated adhesive composition (A) can additionally comprise from 1% to 10% by weight of at least one optional additive, as defined above.

In a particularly preferred embodiment, the total weight of the heat-activated adhesive film comprises:
(A1) from 1% to 95%, preferably from 10% to 40% by weight of at least one thermoplastic polymer having a weight-molecular weight (Mw) no less than 10000 g/mol;
(A2) from 0.01% to 80%, preferably from 5% to 40% by weight of at least one polyol having a weight-molecular weight (Mw) less than 10000 g/mol,
(A3) from 0.05% to 20%, preferably from 0.5% to 5% by weight of at least one polyisocyanate having at least two isocyanate groups and at least one uretdione group in one molecule and
(A4) less than 2.0% by weight, preferably less than 0.5% by weight, preferentially less than 0.1% by weight of at least one organic solvent, based on the total weight of the heat-activated adhesive film.

### Dispersion Composition (B)

According to the present invention, the multi-layer adhesive film comprises a second layer disposed on the first major surface of the first layer. The second layer is derived from a dispersion composition (B) comprising at least one water-based polyurethane dispersion (B1) and optionally a latent curing agent (B2). When peeling from a substrate, a single-layer adhesive film derived from the solvent-based composition (A) typically breaks multiple times, thus resulting in ineffective rework ability. Because the second layer derived from the dispersion composition (B) is highly resistant and can provide a reliable carrier for the first layer, the multi-layer adhesive film not only realizes the outstanding rework ability but also reinforces the impact resistance of the multi-layer adhesive film when cured at a low temperature (no more than 90° C.)

In some embodiments, the second layer derived from a dispersion composition (B) consists of at least one water-based polyurethane dispersion (B1), which renders component (B) a non-reactive polyurethane dispersion adhesive.

In some embodiments, the water-based polyurethane dispersion (B1) used in the present invention has a solid content of less than 50%, preferably no more than 40%.

In some embodiments, the water-based polyurethane dispersion (B1) used in the present invention has a polyurethane polymer with a weight molecular weight (Mw) of 50,000 g/mol to 80,000 g/mol.

Commercial product of water-based polyurethane dispersion (B1) includes Adwel 1665A, Adwel 1676, Adwel 1663, Adwel 1630C available from Wanhua Chemistry, ESACOTE PU 6419 and ESACOTEPU A32D available from Lamberti, NH-102U available from Sam Myung Bio Chem Co., Ltd, ESACOTEPU A32D available from DSM, and DISPERCOLL U XP 2682, DISPERCOLL U XP 2612, DISPERCOLL U XP 2643, DISPERCOLL U XP 2849, DISPERCOLL U 53, DISPERCOLL U 56 available from COVESTRO.

The component mentioned above (B2) can be used singly or preferably in combination with two or more.

In other embodiments, the second layer is derived from a dispersion composition (B) comprising at least one water-based polyurethane dispersion (B1) and a latent curing agent (B2), which renders component (B) a latent-reactive polyurethane dispersion adhesive subject to heat.

Suitable latent curing agents (B2) include a latent-reactive solid isocyanate. Examples include aliphatic, cycloaliphatic, heterocyclic, and aromatic polyisocyanates (e.g. methylene diphenyl diisocyanate (MDI), toluene diisocyanate (TDI)), and isophorone diisocyanate (IPDI)), preferably TDI.

The latent curing agent (B2) preferably comprises groups selected from ethylene diamine, 1,3-propylene-diamine, diethylene triamine, triethylene tetramine, 2,5-dimethyl-piperazine, 3,3′-dimethyl-4,4′-diamino-dicyloheyl, methane, methylnonane-diamine, isophoron diamine, 4,4′-diaminodi cyclohexyl methane, diamino and triamino polypropylene ether, polyamidoamine, and combinations thereof.

It is preferable to use a suspension of latent-reactive solid isocyanate. Preferred aqueous suspension of a latent-reactive solid isocyanate has less than 50% solid content. The desired aqueous suspension of a latent-reactive solid isocyanate has an NCO content value of 5% to 15%, according to the testing method of M105-ISO 11909.

Useful aqueous suspension of a latent-reactive solid isocyanate can be activated at 60° C. to 80° C.

Commercial products of latent curing agent (B2) include CARMOT BL-1045 available from OSIC, and Thanecure® T9 SuperFine available from TSE.

In a particularly preferred embodiment, the second layer is derived from a dispersion composition (B) comprising from 80% to 100% by weight of a water-based polyurethane dispersion (B1) and from 0 to 20% by weight of a latent curing agent (B2).

### Multi-Layer Adhesive Film

According to the present invention, the multi-layer adhesive film comprises a first layer having a first major surface and a second major surface opposite the first major surface, and a second layer disposed on the first major surface of the heat-activated adhesive film.

In some embodiments, at least one detachable liner disposed on the second major surface of the first layer, and at least one detachable liner disposed on the open surface of the second layer.

In some embodiments, the multi-layer adhesive film further comprises a third layer in direct contact with the second major surface of the heat-activated adhesive film, where the third layer is the same or different than the second layer, comprising at least one water-based polyurethane dispersion and optionally a latent curing agent. Optionally, at least one detachable liner disposed on the open surface of the third layer and at least one detachable liner disposed on the open surface of the second layer.

The multi-layer adhesive film has a total thickness ranging from 150 μm to 400 μm, preferably from 200 μm to 300 μm.

According to the present invention, the multi-layer adhesive film features a self-supporting adhesive film. It can be cured at a low temperature, such as lower than 90° C., preferably no more than 80° C. while exhibiting an excellent push-out strength, such as at least 5 MPa according to the testing method described herein, and an outstanding impact resistance, such as at least 0.5 J, preferably at least 0.8 J according to the testing method described herein.

### Preparation Method

According to the second aspect of the invention, the invention relates to a method for preparing a multi-layer adhesive film comprising the following steps:
(1) applying the solvent-based heat-activated adhesive composition (A) according to the invention on a detachable liner and heating to a temperature of from 40° C. to 100° C. until the solvent content is no more than 5% by weight of the total solvent-based heat-activated adhesive composition, cooling to room temperature, thus forming a first layer of the multi-layer adhesive film; and
(2) applying a dispersion composition (B) according to the invention on the first major surface of the heat-activated adhesive film and heating to a temperature of from 40° C. to 100° C. to dry the dispersion composition, cooling to room temperature, thus forming a second layer of the multi-layer adhesive film.

In some embodiments, the multi-layer adhesive film based on the above method comprises the further following steps:
(3) removing the detachable liner from the second major surface of the heat-activated adhesive film and applying a dispersion composition (B) according to the invention and heating to a temperature of from 40° C. to 100° C. C to dry the dispersion composition, cooling to room temperature, thus forming a third layer of the multi-layer adhesive film; and
(4) optionally applying a detachable liner on the second and third layers' open surfaces.

During step (1), the solvent-based heat-activated adhesive composition (A) can be obtained by mixing the thermoplastic polymer (A1), the polyol (A2), and an optional component or additive dissolved in the organic solvent (A4), preferably under hot conditions, for example at a temperature of less than or equal to 75° C., preferably of less than or equal to 65° C., before introducing the polyisocyanate (A3), with rapid stirring, and then the polyisocyanate (A3) can be added at room temperature, to obtain a homogeneous mixture of the solvent-based heat-activated adhesive composition (A).

In step (2), generally, the drying temperature is from 40° C. to 100° C., preferably from 40° C. to no more than 60° C. If the drying temperature is too high, it may affect the filming of the dispersion composition (B); however, even if the drying temperature is as high as 100° C., due to the ample water contained in the dispersion composition (B) and evaporation brings heat away, therefore the actual temperature of the film would not too high to affect filming. The drying time depends on the film thinness, the length of the drying tunnel, and manufacturing capacity. In some embodiments, the second layer was dried at 80° C. for 10 minutes, showing an acceptable filming status for further use.

In step (3), the dispersion component (B) can be the same or different from the second layer, comprising at least one water-based polyurethane dispersion and optionally a latent curing agent according to the present invention.

In some embodiments, the detachable liner used in the above steps has a non-stick surface on which the composition is applied. For instance, the solvent-based heat-activated adhesive composition (A) is applied as a uniform layer to the non-stick surface of a detachable liner, such as a silicone-treated surface. The application can be carried out using a film applicator or bar coater. A double-layer adhesive film is advantageously obtained after steps (1) and (2). A triple-layer adhesive film is advantageously obtained after steps (1) to (4).

Optionally, a multi-layer adhesive film according to the present invention can be prepared by the following steps:
(1) applying the solvent-based heat-activated adhesive composition (A) according to the invention on a detachable liner and heating to a temperature of from 40° C. to 100° C. until the solvent content is no more than 5% by weight of the total solvent-based heat-activated adhesive composition, cooling to room temperature, thus forming a first layer of the multi-layer adhesive film;
(2) applying a dispersion composition (B) according to the invention on a detachable liner and heating to a temperature of from 40° C. to 100° C. to dry the dispersion composition, cooling to room temperature, thus forming a second layer of the multi-layer adhesive film; and
(3) laminating the second layer of the multi-layer adhesive on the first layer of the multi-layer adhesive film under a temperature of 40° C. to 80° C. and a pressure of 1 to 5 bars.

Furthermore, the above preparation method can comprise the following steps:
(4) removing the detachable liner of the first layer of the multi-layer adhesive film and applying a dispersion composition (B) according to the invention, heating to a temperature of from 40° C. to 100° C. to dry the dispersion composition, cooling to room temperature, thus forming a third layer of the multi-layer adhesive film; and
(5) applying a detachable liner on the open surface of the third layer.

The apparatuses for mixing, stirring, dispersing, and the like are not particularly limited during the process. An automated mortar, a Henschel mixer, a three-roll mill, a ball mill, a planetary mixer, a bead mill, and the like can be used, equipped with a stirrer and a heater. Also, an appropriate combination of these apparatuses may be used. The preparation method of the composition (A) or (B) is not particularly limited as long as the above-described components are uniformly mixed.

During the process, the composition (A) or (B) can be applied using any suitable application method including, e.g., automatic fine line dispensing, jet dispensing, slot die coating, roll coating, gravure coating, transfer coating, pattern coating, screen printing, spray coating, filament coating, by extrusion, air knife, trailing blade, brushing, dipping, doctor blade, offset gravure coating, rotogravure coating, and combinations thereof. The composition (A) or (B) can be applied as a continuous or discontinuous coating in single or multiple layers and combinations thereof.

### Article and Use

According to the third aspect, provided herein is an article comprising:
a first substrate,
a second substrate, and
the multi-layer adhesive film according to the present invention disposed between the first substrate and the second substrate.

In another embodiment, an article includes a first substrate, a second substrate, and a multi-layer adhesive film of the invention disposed between the two substrates, and in direct contact with the two substrates.

The first and second substrate can be of a single material and a single layer or multiple layers of the same or different material. The layers can be continuous or discontinuous.

The substrates of the article described herein can have a variety of properties, including rigidity (e.g., rigid substrates, i.e., the substrate cannot be bent by an individual using two hands or will break if an attempt is made to bend the substrate with two hands), flexibility (e.g., flexible substrates, i.e., the substrate can be bent using no greater than the force of two hands), porosity, conductivity, lack of conductivity, and combinations thereof.

The substrates of the article can be in a variety of forms including, e.g., fibers, threads, yarns, wovens, nonwovens, films (e.g., polymer film, metalized polymer film, continuous films, discontinuous films, and combinations thereof), foils (e.g., metal foil), sheets (e.g., metal sheet, polymer sheet, continuous sheets, discontinuous sheets, and combinations thereof), and combinations thereof.

In preferred embodiments, at least one of the substrates can be selected from metals, such as anodic aluminum, metal firing pastes, tin, molybdenum, silver, conductive metal oxides such as indium tin oxide (ITO), fluorine-doped tin oxide, aluminum doped zinc oxide, etc., glasses such as inked glass, bare glass, resins such as polycarbonate, polybutylene, terephthalate and polyamide. Further, suitable metals include copper, gold, palladium, platinum, aluminum, indium, silver-coated copper, silver-coated aluminum, tin, and tin-coated copper. Preferably, both substrates are selected from one of the materials mentioned above.

According to an alternative form of this preferred embodiment, the article can be multi-layer by laminating more substrates using the multi-layer adhesive film according to the present invention.

In one embodiment, an article having a first substrate and a second substrate is prepared by contacting a first substrate with the first major surface of any one of the multi-layer adhesive films after removing the detachable liner, if any, contacting the second substrate with a second major surface of the film after removing the detachable liner if any, such that the second major surface of the film is in direct contact with the second substrate to form the article, and applying heat at a temperature of less than 90° C. preferably from 60° C. to 80° C. and an optional pressure of 0.5 to 6 bars to the article to cure the adhesive film such that the two substrates adhere together.

In another embodiment, an article having a first substrate and a second substrate is prepared by contacting a first substrate with the first major surface of any one of the multi-layer adhesive films, applying heat at a temperature of from 40° C. to 60° C. to the adhesive film before or after the adhesive film is applied to the first substrate to from a pre-laminate, which could be stored and transported to a different location. During the pre-lamination, partial coalescence can occur while the solvent-based heat-activated adhesive composition (A) has not started to cure or crosslink. Once ready, the pre-laminate is used to make the final article by contacting the second substrate with a second major surface of the film such that the second major surface of the film is in direct contact with the second substrate to form the article, and applying heat at a temperature of less than 90° C. preferably from 60° C. to 80° C. and optional pressure (e.g., membrane or bladder press, heated platens) to the article to completely cure the multi-layer adhesive film such that two substrates adhere together through the adhesive film.

As will be understood, the time and temperature curing profile for a multi-layer adhesive film according to the present invention will vary, and different multi-layer adhesive films can be designed to provide the curing profile suited to the particularly industrial manufacturing process.

### Use

A fourth aspect of the invention is the use of the multi-layer adhesive film according to the present invention or the article according to the present invention in manufacturing automobile parts, truck bed covers, textile laminations, assembled goods, and electronic devices.

The multi-layer adhesive film is useful in a variety of applications including, e.g., temporarily bonding at least one substrate, permanently bonding at least one substrate or two substrates, protecting a substrate, inhibiting or preventing the movement of a first substrate relative to a second substrate, and a combination thereof. The multi-layer adhesive film is also useful in various processes, including manufacturing processes (e.g., bonding two parts of an article together and maintaining two parts in fixed relation to one another during the manufacturing process), shipping processes, stacking techniques, and combinations thereof.

The multi-layer adhesive film can be used in the manufacture of a variety of articles including, e.g., automobile parts, truck bed covers, textile laminations, various assembled goods, and electronic devices.

The said suitable electronic devices include but are not limited to, e.g., wearable electronic devices (e.g., wristwatches and eyeglasses), handheld electronic devices (e.g., phones (e.g., cellular telephones and cellular smartphones), cameras, tablets, electronic readers, monitors (e.g., monitors used in hospitals, and by healthcare workers, athletes and individuals), watches, calculators, mice, touch pads, and joysticks), computers (e.g., desktop and laptop computers), computer monitors, televisions, media players, or other electronic components.

### EXAMPLES

The following examples are intended to assist one skilled in the art to better understand and practice the present invention. The scope of the invention is not limited by the examples but is defined in the appended claims. All parts and percentages are based on weight unless otherwise stated.

Raw materials:
WH6190A is a thermoplastic polyurethane polymer having a weight-molecular weight (Mw) of 50,000 g/mol and an optimum activation temperature of 55° C., available from Wanhua Chemical.
FZPE-A03130 is an amorphous polyester polyol having a weight-molecular weight (Mw) of 3000 g/mol, available from GUANGZHOU FTRT CHEMICAL CO., LTD.
Silquest A-189 is a silane, available from Momentive.
Carbon black is a pigment, available from Cabot.
BYK-141 is a defoamer agent, available from BYK.
BYK-3550 is a leveling agent, available from BYK.
Addolink™ TT is toluene diisocyanate dimer, available from Rhein Chemie.
MEK is methyl ethyl ketone having a boiling point of 70° C. to 80° C., available from Sinopharm.
Adwel 1665A is a water-based polyurethane dispersion having a solid content of 50% and having a polyurethane polymer in a weight molecular weight (Mw) of 50,000 g/mol to 80,000 g/mol, available from Wanhua Chemistry.
Adwel 1676 is a water-based polyurethane dispersion having a solid content of 50% and having a polyurethane polymer in a weight molecular weight (Mw) of 50,000 g/mol to 80,000 g/mol, available from Wanhua Chemistry.
CARMOT BL-1045 is a dispersion containing 40% TDI dimer with an NCO content of 7% to 8%, available from OSIC.
METOLAT 348 is a leveling agent, available from MUNZING.
Carboset® 527 is a thermoplastic acrylic resin, available from Lubrizol.
AT501 is a thermoplastic epoxidized elastomer, available from Daicel Corporation.

### Preparation of the Solvent-Based Heat-Activated Adhesive Composition (A) and the First Layer of the Multi-Layer Adhesive Film

The solvent-based heat-activated adhesive composition (A) according to the invention was prepared according to the following steps:
(1) 25 g WH6190A (A1), 5 g FZPE-A03130 (A2), 1 g Silquest A-189, 1 g carbon black, 1.5 g BYK-141, and 1.5 g BYK-3550 were added into 85 g MEK (A4) with slow stirring for approximately 10 hours under the temperature of less than 65° C. until the polymers are dissolved; and
(2) When dissolved, the solution is cooled to room temperature. 1.2 g Addolink™ TT (A3) was subsequently introduced, and then the mixture was transferred into a suitable receptacle and placed under rapid stirring using a high-speed mixer for two times 1 minute at 2000 revolutions per minute (rev/min) to obtain the solvent-based adhesive composition (A) (“F11”).

The solvent-based adhesive composition of F11 was drawn over a detachable liner using a 500 μm film applicator and dried at 40° C. for 20 minutes to evaporate the MEK (A4) until MEK's content is no more than 5% obtain the first layer of a multi-layer adhesive film according to the present invention.

### Preparation of the Dispersion Composition (B) and the Second/Third Layer of the Multi-Layer Adhesive Film

According to the present invention, two dispersion compositions (B), F21 and F22, were prepared by mixing the components identified in Table 1 with slow stirring at a speed of 400 to 800 rpm for approximately 2 hours at room temperature.

The contents shown in table 1 are expressed in grams (g).

TABLE 1

| Components (g) | F21 | F22 |
|---|---|---|
| Adwel 1665A | 70 | 70 |
| Adwel 1676 | 30 | 30 |
| CARMOT BL-1045 | 0 | 10 |
| METOLAT 348 | 1 | 1 |
| Total weight (g) | 115 | 115 |

The dispersion compositions, F21 and F22, were applied on a detachable liner, respectively, or on the first major surface of a heat-activated adhesive film obtained above, heating in an oven at a temperature of 45° C. for 10 minutes to dry the dispersion compositions, and cooling to room temperature, thus forming a second/third layer of the multi-layer adhesive film.

### Comparative Examples 1 to 3

The comparative example 1 was a single-layer of a heat-activated adhesive film of F11.

The comparative examples 2 and 3 are double-layer adhesive films containing a heat-activated adhesive film of F11 as a first layer, while the second layer is derived from the composition of CF1 and CF2 prepared as follows.

Adding a thermoplastic polymer different than the present invention and additive into MEK identified in Table 2 with slow stirring for approximately 10 hours under the temperature of less than 65° C. until the polymers are dissolved to obtain dispersion compositions of “CF1” and “CF2”.

The contents shown in Table 1 are expressed in grams (g).

TABLE 2

| Components (g) | CF1 | CF2 |
|---|---|---|
| Carboset ® 527 | 0 | 25 |
| AT501 | 25 | 0 |
| MEK | 85 | 85 |
| Silane | 1 | 1 |
| Carbon black | 1 | 1 |
| Defoamer agent | 1.5 | 1.5 |
| leveling agent | 1.5 | 1.5 |
| Total weight (g) | 115 | 115 |

In comparative examples 2 and 3, each of the dispersion compositions of CF1 and CF2 was applied on the first major surface of a heat-activated adhesive film F11, heating to a temperature of from 40° C. to 100° C. to dry the dispersion composition of CF1 and CF2, and cooling to room temperature, thus forming the comparative examples of double-layer adhesive film.

### Inventive Examples 1 to 3

Each of the multi-layer adhesive films of Inventive Examples was prepared by applying the dispersion of F21/F22 onto the first major surface of a heat-activated adhesive film F11 at room temperature and placing the coated film in an oven at 45° C. for 10 minutes to evaporate the water, thus forming the second layer. After drying, the double-layer adhesive film was kept at room temperature. A detachable liner is covered onto the open surface of the second layer of the double-layer adhesive film.

In Inventive Example 3, the detachable liner attached to the second major surface was removed, and a dispersion composition of F22 was applied to it and placed in an oven at a temperature of 45° C. for 10 minutes to evaporate the water. After drying, the formed triple-layer adhesive film was kept at room temperature for two days. A detachable liner is covered onto the open surface of the third layer of the triple-layer adhesive film.

Each layer of the multi-layer adhesive film of the Inventive Examples and Comparative Examples' composition, thickness ratio, and total thickness of the adhesive film are shown in Table 3.

### Test Methods

### Push-Out Strength

### Sample Prelamination:

The multi-layer adhesive films of the inventive and the comparative example were cut into pieces with each size of 25×25 mm and then pre-laminated using a test coupon on a heating platform. The test coupon consisted of an anodic aluminum block and a separate window-like component made from anodic aluminum. The adhesive film was applied uniformly onto the surface of the said inked glass block on the platform under the temperature of 50° C. 500 g weight was used to press the adhesive film for 30 seconds. Then, the liner was removed from the adhesive film. Pressing the inked glass block to the window-like component with a bonding area of 225 mm² under the temperature of 60° C. and the pressure of 2 kilograms for another 30 seconds. This pre-lamination step helps activate the thermoplastic polymer's coalescence with an initial bond.

### Final Lamination/Thermal Curable Process:

The specimen obtained above was transferred to a thermo-compressor to perform the final lamination/thermal curable process at 80° C. The thermos-compressor had an upper and bottom flat metal thermos-block (both metal blocks were set up to 80° C. in advance). The final lamination was performed under the pressure of about 2 bar and heating for 10 minutes at 80° C. (usually, 3 to 6 test specimens were heating pressed at one time), during which the adhesive film crosslinked and cured. Transferring the specimen from the thermos-compressor to room temperature, then continuing to compress with 2 kilograms weight for 6 minutes.

### Sample Testing

The push-out strength test was performed using a universal testing machine with a punch at 23±2° C. and 50%+5% relative humidity. The punch applied a compressing force on the metal block of the test coupon at a pushing speed of 10 mm/min till the assembly could no longer support a load. The maximum load was recorded in Table 3, and the push-out strength was calculated by dividing the total load by the bonding area.

The adhesive film exhibiting a push-out strength of at least 5 MPa is acceptable.

### Impact Resistance

The impact resistance of the samples was evaluated by Du Pont impact energy using a lap-shear assembly.

The sample preparation, pre-lamination, and final curing condition were the same as the push-out strength test described above.

### Sample Testing:

A 50 g weight was dropped on the specimen from a height of 1 m as a starting point at a speed of 4.43 m/s. If the substrate was not peeled from the polycarbonate substrate three times, then raising the weight to a height of 2 cm higher than the previous height to drop. The Du Pont impact energy was calculated using the following equation:

$$E = m * g * h * 0.01 ,$$

wherein E is impact energy (J), m is the weight (g) when substrates were peeled from each other, h is the height (m) of the weight loosed from when substrates were peeled from each other, and g is 9.8 m/s2. The test results are shown in Table 3. The Du Pont impact energy value of at least 0.5 J, preferably at least 0.8 J is an acceptable impact resistance.

### Rework Ability Test

The rework ability of the samples was evaluated according to the below method.

### Sample Preparation

An assembly structure having a first substrate of anodic aluminum and a second substrate of ink glass was prepared by contacting a first substrate with the second major surface of a first layer or the open surface of a third layer of the multi-layer adhesive film in Inventive Examples, or mono- or multi-layer adhesive films of the comparative examples, after removing the detachable liner if any, contacting the second substrate with an open surface of the second layer of the multi-layer adhesive film after removing the detachable liner if any, such that the second layer of the film was in direct contact with the second substrate to form the assembly structure, and applying heat at a temperature of 80° C. and a pressure of 2 bars to cure the adhesive film such that the two substrates adhere together.

### Sample Testing

Debonding the first substrate from the assembly structure first, then using a palette knife to peel off the adhesive film from the second substrate and using hand to continue peeling off the film controlled at 30 to 45 degrees from the second substrate surface at room temperature. The adhesive film's status and the rework ability level were evaluated and shown in Table 3. The rework ability level 5 represents an outstanding rework ability level.

| Rework | |
|---|---|
| ability | |
| Scale | Description |
| 5 | The adhesive film can peel off with no residue left on the |
| | substrate, and the film does not break when peeling. |
| 4 | The adhesive film can peel off with no residue left on the |
| | substrate, but the film breaks one time when peeling. |
| 3 | The adhesive film can peel off easily with no residue left |
| | on the substrate, but the film breaks two times or more |
| | when peeling. |
| 2 | The substrate adhesive film can peel off, but residue remains |
| | on the substrate. |
| 1 | The adhesive film cannot peel off from the substrate. |

TABLE 3

| Adhesive film | | | | | | |
|---|---|---|---|---|---|---|
| components and | Comparative | Comparative | Comparative | Inventive | Inventive | Inventive |
| properties | Example 1 | Example 2 | Example 3 | Example 1 | Example 2 | Example 3 |
| The second layer | / | CF1 | CF2 | F21 | F22 | F22 |
| The first layer | F11 | F11 | F11 | F11 | F11 | F11 |
| The third layer | / | / | / | / | / | F22 |
| Thickness Ratio | / | 1:1 | 1:1 | 1:1 | 1:1 | 1:1:1 |
| of each layer | | | | | | |
| Thickness/um | 200 | 200 | 200 | 200 | 200 | 200 |
| Testing results | | | | | | |
| Push-out strength | 5.00 | 3.16 | 2.97 | 5.00 | 5.5 | 6.16 |
| (mPa) | | | | | | |
| Impact resistance (J) | 0.05 | 0.20 | 0.30 | 0.90 | 1.40 | 2.10 |
| Rework ability level | Level 3 | Level 5 | Level 5 | Level 5 | Level 5 | Level 5 |

Although some preferred embodiments have been described, many modifications and variations may be made thereto in light of the above teachings. It is therefore to be understood that the invention may be practiced otherwise than as specifically described without departing from the scope of the appended claims.

What is claimed is:

1. A multi-layer adhesive film comprising:
a first layer having a first major surface and a second major surface opposite the first major surface, and
a second layer disposed on the first major surface of the heat-activated adhesive film;
wherein the first layer is a heat-activated adhesive film prepared by drying a solvent-based heat-activated adhesive composition (A) until the solvent content is no more than 5% by weight of the total solvent-based heat-activated adhesive composition, and the solvent-based heat-activated adhesive composition (A) comprises at least one thermoplastic polymer (A1), at least one polyol (A2), at least one polyisocyanate having at least two isocyanate groups and at least one uretdione group in one molecule (A3) and an organic solvent (A4);
wherein the second layer is derived from a dispersion composition (B) comprising at least one water-based polyurethane dispersion (B1) and optionally a latent curing agent (B2).

2. The multi-layer adhesive film according to claim 1, wherein the thermoplastic polymer (A1) has an optimum activation temperature of no greater than 100° C.

3. The multi-layer adhesive film according to claim 1, wherein the thermoplastic polymer (A1) has a weight-molecular weight (Mw) no less than 10,000 g/mol.

4. The multi-layer adhesive film according to claim 1, wherein the polyol (A2) is a polyester polyol having a weight-molecular weight (Mw) less than 10,000 g/mol.

5. The multi-layer adhesive film according to claim 1, wherein the heat-activated adhesive composition (A) has an NCO/OH molar ratio ranging from 0.1 to 8:1.

6. The multi-layer adhesive film according to claim 1, wherein the water-based polyurethane dispersion (B1) has a solid content of at least 40% to 70%.

7. The multi-layer adhesive film according to claim 8, wherein the water-based polyurethane dispersion (B1) has a weight molecular weight (Mw) of 50,000 g/mol to 80,000 g/mol.

8. The multi-layer adhesive film according to claim 1, wherein the latent curing agent (B2) is an aqueous suspension of a latent reactive solid isocyanate.

9. The multi-layer adhesive film according to claim 1, wherein the multi-layer adhesive film further comprises a third layer in direct contact with the second major surface of the heat-activated adhesive film, where the third layer is the same or different than the second layer, comprising at least one water-based polyurethane dispersion and optionally a latent curing agent.

10. The multi-layer adhesive film according to claim 1, wherein the multi-layer adhesive film has a total thickness ranging from 150 μm to 400 μm.

11. A method for preparing a multi-layer adhesive film comprising the following steps:
(1) applying the solvent-based heat-activated adhesive composition (A) according to claim 1 on a detachable liner and heating to a temperature of from 40° C. to 100° C. until the solvent content is no more than 5% by weight of the total solvent-based heat-activated adhesive composition, cooling to room temperature, thus forming a first layer of the multi-layer adhesive film; and
(2) applying a dispersion composition (B) on the first major surface of the heat-activated adhesive film and heating to a temperature of from 40° C. to 100° C. to dry the dispersion composition, cooling to room temperature, thus forming a second layer of the multi-layer adhesive film.

12. The method for preparing a multi-layer adhesive film according to claim 11 comprising the further following steps:
(3) removing the detachable liner from the second major surface of the heat-activated adhesive film and applying a dispersion composition (B) heating to a temperature of from 40° C. to 100° C. to dry the dispersion composition, cooling to room temperature, thus forming a third layer of the multi-layer adhesive film; and
(4) optionally applying a detachable liner on the second and third layers' open surfaces.

13. A method for preparing a multi-layer adhesive film comprising the following steps:
(1) applying the solvent-based heat-activated adhesive composition (A) according to claim 1 on a detachable liner and heating to a temperature of from 40° C. to 100° C. until the solvent content is no more than 5% by weight of the total solvent-based heat-activated adhesive composition, cooling to room temperature, thus forming a first layer of the multi-layer adhesive film;
(2) applying a dispersion composition (B) on a detachable liner and heating to a temperature of from 40° C. to 100° C. to dry the dispersion composition, cooling to room temperature, thus forming a second layer of the multi-layer adhesive film; and
(3) laminating the second layer of the multi-layer adhesive on the first layer of the multi-layer adhesive film under a temperature of 40° C. to 80° C. and a pressure of 1 to 5 bars.

14. An article comprising:
a first substrate,
a second substrate, and
the multi-layer adhesive film according to claim 1 disposed between the first substrate and the second substrate.
